(19) United States
(12) Patent Application Publication
(10) Pub. No.: US 2008/0144308 A1
(43) Pub. Date: Jun. 19, 2008

(54) Writing Utensil-Flashlight Adaptor

(76) Inventors: Jerry R. Salerno, Madison, WI (US); Anita Salerno, Madison, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/859,877

(22) Filed: Sep. 24, 2007

Related U.S. Application Data
(63) Continuation-in-part of application No. 11/639,037, filed on Dec. 14, 2006, now abandoned.

(51) Int. Cl. B43K 29/10

(52) U.S. Cl. 362/118; 401/195

(57) ABSTRACT

An apparatus comprised of: a generally tubular and closed writing utensil sheath formed by a first thin sidewall and adapted to receive a writing utensil; a generally tubular and closed lighting device sheath, formed by a second sidewall, positioned adjacent to the writing utensil sheath, and adapted to receive a lighting device; and a connecting portion connecting the writing utensil sheath to the lighting device sheath such that the lighting device illuminates a writing surface when the writing utensil is in use. The sheaths can further include teeth to keep the writing utensil and lighting device in place. The sheaths can be parallel to one another or somewhat non-parallel to more specifically direct the light at the writing surface when in use. In one embodiment, both of the sidewalls of the sheaths are less than or equal to approximately one eighth of an inch thick. In one embodiment, the connecting portion includes two flat surfaces that are substantially parallel to one another.

### CROSS-REFERENCE TO RELATED APPLICATIONS

This application claims the benefit of and priority to U.S. non-provisional application Ser. No. 11/639,037, filed on Dec. 14, 2006 and incorporated herein in its entirety.

### FIELD OF INVENTION

This invention relates generally to the field of writing utensils and flashlights, and in particular to the field of a device that holds both a writing utensil and a flashlight for illuminating a writing surface when the writing utensil is in use.

### BRIEF DESCRIPTION OF THE DRAWINGS

FIG. 1 shows a top perspective view of one embodiment of the writing utensil-flashlight adaptor, with a writing utensil and a flashlight shown in dashed lines.

FIG. 2a shows a front view of the embodiment of the writing utensil-flashlight adaptor taken along line 2-2 of FIG. 1.

FIGS. 2b and 2c show front views of two alternate embodiments of a writing utensil-flashlight adaptor as compared to that shown in FIG. 2a.

FIG. 3a shows a side view of the embodiment of the writing utensil-flashlight adaptor taken along line 3-3 of FIG. 1.

FIG. 3b shows a side view of one alternate embodiment of the writing utensil-flashlight adaptor shown in FIG. 3a.

FIG. 4 is a front view of an alternate embodiment of the writing utensil-flashlight adaptor further including teeth.

### BACKGROUND

It is frequently necessary to take notes or otherwise record example, in a darkened theater or lecture hall, an observer wishing to record impressions or take notes would be unable to do so in the absence of some convenient means of illuminating the writing surface. Some occupations require the completion of log books and forms in the dark or in dark vehicles, including truck drivers, cab drivers, delivery persons, insurance adjusters and appraisers, and law enforcement personnel. Other jobs, for example food servers, often require writing in dimly lit conditions. Doctors and nurses must write important medical information on patients' room charts without turning on the lights and disturbing them. Travelers too, in automobiles, buses, trains, and airplanes at night, also face this situation, as do campers and anyone who has lost electricity to their home.

At the same time, any illuminating device should serve the writers purpose without casting distracting light over adjacent areas. Mini-flashlights produce a relatively narrow beam of light suitable for this purpose are available, and various arrangements for combining such a light source with a writing instrument have been proposed.

This invention relates generally to the field of writing utensils and flashlights, and in particular to the field of a device that holds both a writing utensil and a flashlight, such that the writing surface is effectively illuminated for the writer, without interfering with the writer's grip on the writing utensil.

As used herein the term “writing utensil” refers to any writing instrument, including but not limited to an ink pen, a felt tip pen, a standard pencil, a retractable pencil, a colored pencil, a grease pencil, a marker, a highlighter, a paint brush, a quill, and a crayon.

As used herein the term “lighting device” refers to any device capable of producing light in a directed manner, examples of which include, but are not limited to, a flash light and a pen light.

### DETAILED DESCRIPTION OF EMBODIMENTS OF THE INVENTION

For the purpose of promoting an understanding of the present invention, references are made in the text hereof to embodiments of a writing utensil-flashlight adaptor, only some of which are depicted in the figures. It should nevertheless be understood that no limitations on the scope of the invention are thereby intended. One of ordinary skill in the art will readily appreciate that modifications such as the size and shape of the components, positioning of the components relative to one another, materials from which the adaptor is made, and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed system, structure, or manner.

It should be understood that all of the drawings are not necessarily to scale, emphasis instead being placed upon illustrating the principles of the invention. In addition, in the embodiments depicted herein, like reference numerals refer to identical structural elements in the various drawings

Moreover, the term “substantially” or “approximately” as used herein may be applied to modify any quantitative representation that could permissibly vary without resulting in a change in the basic function to which it is related. For example, one embodiment of a writing utensil-flashlight adaptor is disclosed herein as including two (2) tubular sections positioned substantially parallel to each other. The tubular sections might permissibly be somewhat non-parallelly disposed relative to one another and still be within the scope of the invention if its functionality is not materially altered.

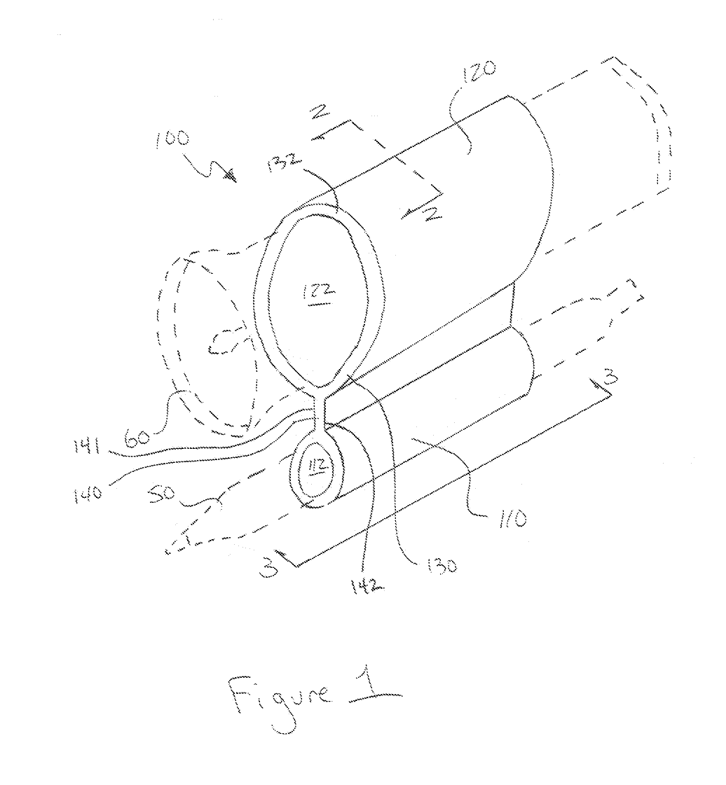

Referring now to the drawings, FIG. 1 shows a top perspective view of one embodiment of writing utensil-flashlight adaptor 100, with pen 50 (one (1) example of a writing utensil) and flashlight 60 shown in dashed lines. The embodiment of writing utensil-flashlight adaptor 100 shown includes writing utensil sheath 110 and lighting device sheath 120, with connecting portion 140 between writing utensil sheath 110 and lighting device sheath 120. Writing utensil sheath 110 is generally tubular and forms first bore 112, into which writing utensil 50 can be positioned. Lighting device sheath 120 is also generally tubular and forms second bore 122, into which flashlight 60 can be positioned. In the embodiment shown, writing utensil sheath 110 and lighting device sheath 120 are formed as one integral piece and made of polyvinyl plastic (PVC). However, it should be understood that writing utensil sheath 110 and lighting device sheath 120 can also be formed as separate pieces, connected by a third piece, i.e., connecting portion 140. It should also be understood that writing utensil-flashlight adaptor 100 can be made of any other material that capable of being shaped, carved, molded, extruded, combined, or stamped to form the shape and for the purpose described herein. The PVC used in the embodiment shown also provides a rubber-like, smooth, and non-greasy surface, which allows for ease of gripping. A user (not shown) grips writing utensil sheath 110, with writing utensil 50 positioned therein, and flashlight 60, positioned within second bore 122 of lighting device sheath 120, illuminates the writing surface (also not shown).

In the embodiment shown in FIG. 1, writing utensil-flashlight adaptor 100 is 2.5 inches long and 1.515 inches tall. Sidewalls 131, 132 are 0.085 inches thick, except that portion which connects writing utensil sheath 110 to lighting device sheath 120 (i.e., connecting portion 140), which is 0.250 inches thick. One of ordinary skill in the art will readily recognize that the length and height of utensil-flashlight adaptor 100 can be of any alternate length and height and that sidewalls 131, 132 can be of any alternate thickness. However, sidewall 131 of writing utensil sheath 110 should be less than approximately 0.125 inches (⅛″) thick so that the user grips utensil-flashlight adaptor 100 substantially as she would grip writing utensil 50 if it were not positioned within utensil-flashlight adaptor 100. That is, writing utensil-flashlight adaptor 100 should position flashlight 60 alongside writing utensil 50 and can increase the quality of the grip (i.e., prevent slippage), but should not significantly affect the position of the fingers and hand during the grip of utensil-flashlight adaptor 100. In addition, the thickness of sidewalls 131, 132 also need not be uniform. That is, sidewall 131 of writing utensil sheath 110 need not be the same thickness as that of sidewall 132 of lighting device sheath 120. In one (1) alternate embodiment of utensil-flashlight adaptor 100, sidewall 132 of lighting device sheath 120 is thicker than sidewall 131 of writing utensil sheath 110 to increase the stability of lighting device 60 while utensil-flashlight adaptor 100 is in use.

In the embodiment shown, first bore 112 is 0.320 inches wide to accommodate pen 50. However, it should be understood that pen 50 could alternately be any writing utensil, and first bore 112 could be of alternate diameter to accommodate other types of writing utensils, including but not limited to an ink pen, a felt tip pen, a standard pencil, a retractable pencil, a colored pencil, a grease pencil, a marker, a highlighter, a paint brush, a quill, and a crayon.

Second bore 122 is 0.750 inches wide to accommodate flashlight 60 and is substantially parallel with first bore 112. In the embodiment shown, second bore 122 is sized specifically to accommodate a Mini Maglite® flashlight. However, it should be understood that second bore 122 can be sized to accommodate any alternate lighting device capable of producing light in a directed manner, including but not limited to other types of flashlights or penlights.

Connecting portion 140 connects writing utensil sheath 110 with lighting device sheath 120 and includes first side surface 141 and second side surface 142. First side surface 141 and second side surface 142 are both flat and substantially parallel to each other.

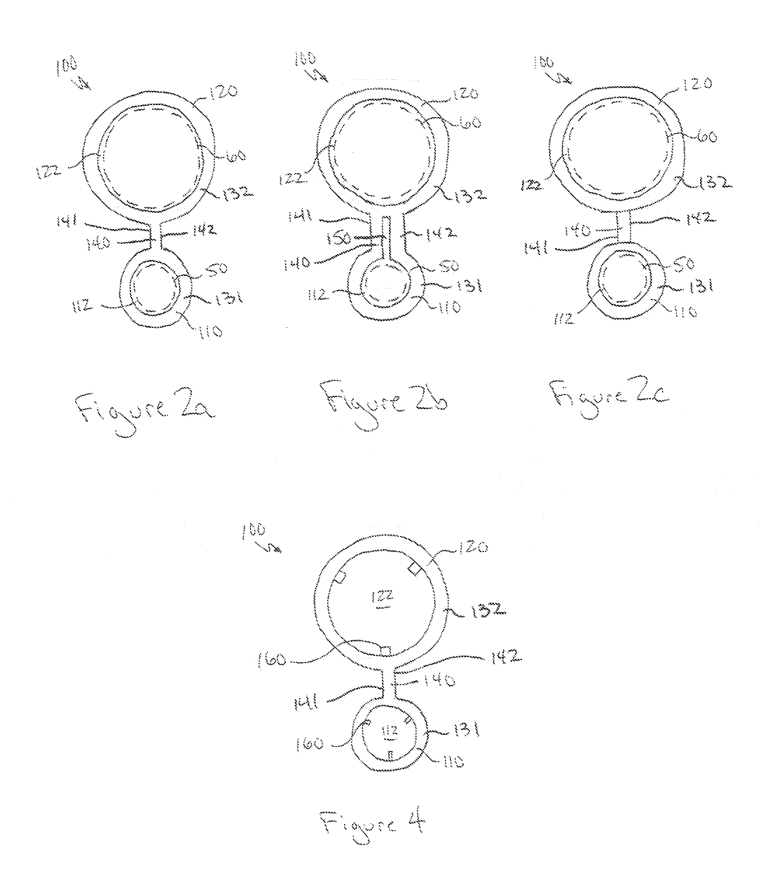

FIG. 2a shows a front view of the embodiment of writing utensil-flashlight adaptor 100 taken along line 2-2 of FIG. 1. Again, FIG. 2a is not drawn to scale, but writing utensil sheath 110, first bore 112, lighting device sheath 120, second bore 122, sidewalls 131, 132, connecting portion 140, and the positions of writing utensil 50 and flashlight 60 relative to writing utensil-flashlight adaptor 100 can all be appreciated. In this embodiment of utensil-flashlight adaptor 100, it can be seen that first bore 112 and second bore 122 are separated by connecting portion 140, as well as that first side surface 141 of connecting portion 140 and second side surface 142 of connecting portion 140 are substantially flat and substantially parallel to each other.

FIGS. 2b and 2c show front views of two alternate embodiments of a writing utensil-flashlight adaptor 100 as compared to the embodiment shown in FIG. 2a. FIG. 2b shows an embodiment in which the center of writing utensil-flashlight adaptor 100 is open, designated by number 150. First bore 112 and second bore 122 are not completely enclosed and are partially open at center portion 150. However, writing utensil 50 and flashlight 60 are still held within writing utensil sheath 110 and lighting device sheath 120, respectively, of utensil-flashlight adaptor 100. FIG. 2c shows yet another alternate embodiment in which writing utensil sheath 110 and lighting device sheath 120 are connected by an alternate embodiment of connecting portion 140. In this embodiment, writing utensil-flashlight adaptor 100 is constructed of three (3) separate components and then assembled. As can be appreciated, first side surface 141 of connecting portion 140 and second side surface 142 of connecting portion 140 are both substantially flat and parallel to each other in both alternate embodiments.

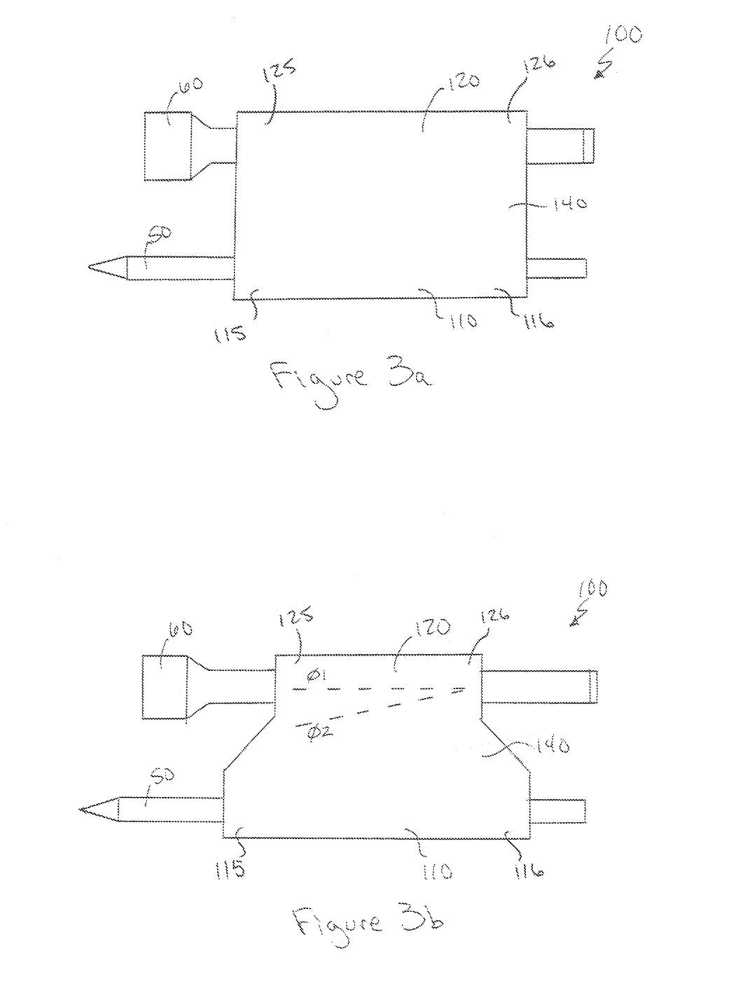

FIG. 3a shows a side view of the embodiment of writing utensil-flashlight adaptor 100 taken along line 3-3 of FIG. 1. In this embodiment, writing utensil sheath 110 and lighting device sheath 120 are equal in length. FIG. 3b shows a side view of one (1) alternate embodiment of writing utensil-flashlight adaptor 100 in which writing utensil sheath 110 is longer in length than the length of lighting device sheath 120. In this embodiment, both forward portion 115 and rearward portion 116 of writing utensil sheath 110 are shorter than that forward portion 125 and rearward portion 126 of lighting device sheath 120. It should be understood that in alternate embodiments of writing utensil-flashlight adaptor 100, writing utensil sheath 110 could be longer than lighting device sheath 120 only at forward portion 115 or only at rearward portion 116; that writing utensil sheath 110 could be longer than lighting device sheath 120; that writing utensil sheath 110 and lighting device sheath 120 could be equal in length, but offset (e.g., forward portion 115 of writing utensil sheath 110 is forward of forward portion 125 of lighting device sheath 120, and rearward portion 116 of writing utensil sheath 110 is forward of rearward portion 126 of lighting device sheath 120); and that writing utensil sheath 110 could be longer or shorter than lighting device sheath 120, but offset as well. Thus, one of ordinary skill in the art should appreciate that the lengths of writing utensil sheath 110 and lighting device sheath 120 are not material to practicing the invention.

It should also be understood that flashlight 60 and writing utensil 50 are positioned substantially parallel to one another in the embodiments of writing utensil-flashlight adaptor 100 shown in FIGS. 3a and 3b. Referring specifically to FIG. 3b, flashlight 60 is shown parallelly positioned relative to writing utensil 50, as designated by θ1. However, in an alternate embodiment of writing utensil-flashlight adaptor 100, the bore (not shown) through which flashlight 60 is held can be angled such that the illuminating portion is more directly illuminating that portion of writing utensil 50 in contact with the writing surface, designated by θ2.

FIG. 4 is a front view of an alternate embodiment of writing utensil-flashlight adaptor 100 further including teeth 160. Teeth 160 are positioned within bores 112, 122 and aid in temporarily securing the writing utensil (not shown) and the flashlight (not shown) within writing utensil-flashlight adaptor 100. The embodiment of writing utensil-flashlight adaptor 100 shown in FIG. 4 includes three (3) teeth 160 within each bore 112, 122. However, it should be understood that any number of teeth 160 could be used, and the number of teeth 160 within each bore 112, 122 need not be identical. Other embodiments may have no teeth, or may have teeth that are either flexible or rigid.

While the writing utensil-flashlight adaptor has been shown and described with respect to several embodiments in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. An apparatus comprised of:
a generally tubular and closed writing utensil sheath, said writing utensil sheath formed by a first sidewall and adapted to receive a writing utensil, wherein said first sidewall is less than or equal to approximately one eighth of an inch thick;
a generally tubular and closed lighting device sheath, said lighting device sheath formed by a second sidewall, positioned adjacent to and substantially parallel to said writing utensil sheath, and adapted to receive a lighting device, wherein said lighting device is adapted to illuminate a writing surface; and
a connecting portion, said connecting portion connecting said writing utensil sheath to said lighting device sheath and having a first side surface and a second side surface, said first side surface and said second side surface being substantially flat and substantially parallel to each other.

2. The apparatus of claim 1, wherein said apparatus is made of polyvinyl chloride.

3. The apparatus of claim 1, wherein said writing utensil sheath forms a first longitudinal bore therethrough and said lighting device sheath forms a second longitudinal bore therethrough, said first longitudinal bore having a first plurality of teeth disposed therein and said second longitudinal bore having a second plurality of teeth disposed therein.

4. The apparatus of claim 1, wherein said writing utensil sheath and said lighting device sheath are equal in length.

5. The apparatus of claim 1, wherein said writing utensil sheath and said lighting device sheath are unequal in length.

6. The apparatus of claim 1, wherein said first sidewall and said second sidewall are of unequal thickness.

7. The apparatus of claim 1, wherein said first sidewall and said second sidewall are of equal thickness.

8. A device adapted for grasping by a human hand and positioning a writing utensil substantially alongside a lighting device consisting essentially of:
a generally tubular and closed writing utensil sheath, said writing utensil sheath formed by a first sidewall and adapted to receive said writing utensil;
a generally tubular and closed lighting device sheath, said lighting device sheath formed by a second sidewall, positioned adjacent to and substantially parallel to said writing utensil sheath, and adapted to receive said lighting device, wherein said lighting device is adapted to illuminate a writing surface; and
at least one connecting portion, said at least one connecting portion connecting said writing utensil sheath to said lighting device sheath and having a first side surface and a second side surface, said first side surface and said second side surface being substantially flat and substantially parallel to each other;
wherein said first sidewall and said second sidewall are each less than or equal to approximately one eighth of an inch thick.

9. The device of claim 8, wherein said apparatus is made of polyvinyl chloride.

10. The device of claim 8, wherein said first section forms a first longitudinal bore therethrough and said second section forms a second longitudinal bore therethrough, said first longitudinal bore having a first plurality of teeth disposed therein and said second longitudinal bore having a second plurality of teeth disposed therein.

11. The device of claim 8, wherein said writing utensil sheath and said lighting device sheath are equal in length.

12. The device of claim 8, wherein said writing utensil sheath and said lighting device sheath are unequal in length.

13. A device consisting essentially of:
a writing utensil sheath formed by a substantially thin first sidewall, said writing utensil sheath having a first longitudinal and closed bore therethrough and adapted to receive a writing utensil within said first longitudinal and closed bore;
a first plurality of teeth within said first longitudinal and closed bore;
a lighting device sheath formed by a substantially thin second sidewall, said lighting device sheath having a second longitudinal and closed bore therethrough and adapted to receive a lighting device within said second longitudinal and closed bore;
a second plurality of teeth within said second longitudinal and closed bore; and
a connecting portion, said connecting portion connecting said writing utensil sheath to said lighting device sheath.

14. The device of claim 13, wherein said device is made of polyvinyl chloride.

15. The device of claim 13, wherein said writing utensil sheath and said lighting device sheath are parallel to one another.

16. The device of claim 13, wherein said writing utensil sheath and said lighting device sheath are substantially non-parallel to one another.

17. The device of claim 13, wherein said writing utensil sheath and said lighting device sheath are equal in length.

18. The device of claim 13, wherein said writing utensil sheath and said lighting device sheath are unequal in length.

19. The device of claim 13, wherein said first sidewall and said second sidewall each have a thickness of less than or equal to approximately one eighth of an inch.

20. The device of claim 13, wherein said connecting portion is comprised of a first side surface and a second side surface, said first side surface and said second side surface both being substantially fiat and substantially parallel to each other.
